(19) United States
(12) Patent Application Publication
(10) Pub. No.: US 2013/0239010 A1
(43) Pub. Date: Sep. 12, 2013

(54) CLIENT APPARATUS, CLIENT CONTROL METHOD, SERVER AND IMAGE PROVIDING METHOD USING THE SERVER

(71) Applicant: SAMSUNG ELECTRONICS CO., LTD., Suwon-si (KR)

(72) Inventors: Hyun-woo LIM, Seoul (KR); Do-young JOUNG, Seoul (KR); Sung-kee KIM, Hwaseong-si (KR); Dae-hyung KWON, Seoul (KR); Duk-gu SUNG, Seoul (KR)

(73) Assignee: SAMSUNG ELECTRONICS CO., LTD., Suwon-si (KR)

(21) Appl. No.: 13/761,876

(22) Filed: Feb. 7, 2013

(30) Foreign Application Priority Data
Mar. 6, 2012 (KR) 10-2012-0022936

(51) Int. Cl. G06F 3/0484

(52) U.S. Cl. CPC G06F 3/0484
USPC 715/740

(57) ABSTRACT

A client apparatus which performs communication with a server is provided. The client apparatus includes a display unit which receives a user's touch manipulation through a touch sensor; a communication interface unit which transmits information corresponding to the user's touch manipulation to the server; and a control unit which, when an image corresponding to the user's touch manipulation is received from the server through the communication interface unit, controls the display unit to display the received image.

### CROSS-REFERENCE TO RELATED APPLICATIONS

This application claims priority from Korean Patent Application No. 10-2012-0022936, filed in the Korean Intellectual Property Office on Mar. 6, 2012, the disclosure of which is incorporated herein by reference.

### BACKGROUND

1. Field

Methods and apparatuses consistent with the exemplary embodiments relate to a client apparatus, a client control method, a server and an image providing method of the server, and more particularly to a client apparatus which forms a thin client network system or a zero client network system, and a client control method, a server and an image providing method of the server thereof.

2. Description of the Related Art

Thanks to the recent development of electronic technologies, we have come to use server-based structures. In a server-based structure, all applications are placed in a server, and a client apparatus accesses the server whenever it needs a program. In such a case, the client apparatus does not download and use the software, but instead, all applications are executed in the server, and the client apparatus only receives result values from the server. Such a structure is called a thin client network system or zero client network system.

In a thin client or zero client environment, a memory or hard disk capacity of the client apparatus does need not be large. Furthermore, as long as the client apparatus is connected with the server or network, a CD ROM or floppy disk drive need not be attached to the client apparatus. Therefore, it is possible to reduce a burden of increased network infrastructure, upgrading H/W and S/W of an existing PC, and repair and maintenance expenses etc.

In the past, client apparatuses used to have a keyboard or mouse as an input means to receive control commands from a user. However, in such a case, the client apparatuses had to have an additional driver to use the input means, and thus it was difficult to reduce expenses. Furthermore, in view of the fact that a touch input device is becoming more widely used, an input means such as a keyboard or mouse may cause inconvenience to the user.

Therefore, there is a need for a thin client network system or zero client network system that incorporates a touch input means.

### SUMMARY

An aspect of the exemplary embodiments relates to a client apparatus which may be embodied as a thin client network system or a zero client network system incorporating a touch input means, and a client control method, a server, and an image providing method of the server thereof.

According to an exemplary embodiment of the present disclosure, a client apparatus which performs communication with a server and operates may include a display which receives a user's touch manipulation through a touch sensor; a communication interface which transmits information corresponding to the user's touch manipulation to the server; and a controller which, when an image corresponding to the user's touch manipulation is received from the server through the communication interface, controls the display to display the received image.

The controller may detect information on a location where the user's touch manipulation is input on the display, and control the communication interface to receive an image corresponding to the detected location information from the server.

In addition, when the detected location information corresponds to a text area of the image displayed on the display, the controller may control the communication interface to receive an image which includes a virtual keyboard from the server, and control the display to display the image which includes a virtual keyboard.

According to an exemplary embodiment of the present disclosure, the client apparatus may further include a storage which stores mapping information mapped according to a type of the user's touch manipulation, wherein the controller determines a type of the user's touch manipulation based on the mapping information in the storage, and controls the communication interface to transmit the mapping information corresponding to the type of the user's touch manipulation to the server.

In addition, the client apparatus may be embodied as a thin client apparatus or a zero client apparatus.

According to an exemplary embodiment of the present disclosure, a server which performs communication with a client apparatus, and controls operations of the client apparatus may include a communication interface which receives information corresponding to a user's touch manipulation input into the client apparatus; and a controller which generates an image corresponding to the user's touch manipulation based on the received information, and controls the communication interface to transmit the generated image to the client apparatus.

The controller may control the communication interface to receive information on a location where the user's touch manipulation is input from the client apparatus, and the controller may generate an image corresponding to the location information and control the communication interface to transmit the generated image to the client apparatus.

In addition, the controller may determine the information on the location where the user's touch manipulation is input corresponds to a text area of the image displayed on the client apparatus, and may generate an image which includes a virtual keyboard, and control the communication interface to transmit the image which includes the virtual keyboard.

The controller may receive mapping information corresponding to a type of the user's touch manipulation, and rearrange the image according to the received mapping information, and control the communication interface to transmit the rearranged image to the client apparatus.

In addition, the client apparatus may be embodied as a thin client apparatus or zero client apparatus.

According to an exemplary embodiment of the present disclosure, a control method for a client apparatus which performs communication with a server may include receiving an input of a user's touch manipulation through a touch sensor; transmitting information corresponding to the user's touch manipulation to the server; receiving an image corresponding to the user's touch manipulation from the server; and displaying the received image.

The control method may further include detecting information on a location where the user's touch manipulation is input, and transmitting the detected location information to the server and receiving an image corresponding to the detected location information from the server.

The received image may include a virtual keyboard from the server when the detected location information corresponds to a text area of the displayed image.

The control method may further include storing mapping information mapped according to a type of the user's touch manipulation; and determining the type of the user's touch manipulation based on the stored mapping information, and transmitting mapping information corresponding to the type of the user's touch manipulation to the server.

In addition, the client apparatus may be embodied as a thin client apparatus or a zero client apparatus.

According to an exemplary embodiment of the present disclosure, an image providing method of a server which performs communication with a client apparatus and controls operations of the client apparatus may include receiving information corresponding to a user's touch manipulation input into the client apparatus; and generating an image corresponding to the user's touch manipulation based on the received information, and transmitting the generated image to the client apparatus.

The information corresponding to a user's touch manipulation includes information on a location where the user's touch gesture is input from the client apparatus, and the generated image may correspond to the location information.

In addition, when the information on the location where the user's touch manipulation is input corresponds to a text area of the image displayed on the client apparatus, the generated image is generated to include a virtual keyboard.

The image providing method may further include receiving mapping information corresponding to a type of the user's touch manipulation, and rearranging the image according to the received mapping information and transmitting the rearranged image to the client apparatus.

In addition, the client apparatus may be embodied as a thin client apparatus or a zero client apparatus.

According to an exemplary embodiment, a client apparatus which performs communication with a server includes: a touch sensor which receives a user's touch manipulation; and a communication interface which transmits information about the user's touch manipulation to the server and receives an image corresponding to the user's touch manipulation from the server; and a controller which controls a display to display the received image.

According to the various exemplary embodiments of the present disclosure, it is possible to establish a thin client or a zero client environment using a touch input means, reducing expenses and providing convenience to users who are used to touch input means.

### BRIEF DESCRIPTION OF THE DRAWINGS

The above and/or other aspects of the present disclosure will be more apparent by describing certain exemplary embodiments with reference to the accompanying drawings, in which:

FIG. 1 is a view illustrating an image providing system according to an exemplary embodiment of the present disclosure;

FIG. 2 is a block diagram illustrating a configuration of a client apparatus according to an exemplary embodiment of the present disclosure;

FIG. 3 is a block diagram illustrating in detail a client apparatus according to an exemplary embodiment of the present disclosure;

FIG. 4 is a block diagram illustrating a configuration of a server according to an exemplary embodiment of the present disclosure;

FIGS. 5A to 5F are views illustrating an image displayed on a client apparatus according to an exemplary embodiment of the present disclosure;

FIG. 6 is a view illustrating a transmission packet which a client apparatus transmits to a server according to an exemplary embodiment of the present disclosure;

FIG. 7 is a flowchart illustrating a control method of a client apparatus according to an exemplary embodiment of the present disclosure; and

FIG. 8 is a flowchart illustrating an image providing method of a server according to an exemplary embodiment of the present disclosure.

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

Although a few embodiments of the present invention have been shown and described, it would be appreciated by those skilled in the art that changes may be made in this embodiment without departing from the principles and spirit of the invention, the scope of which is defined in the claims and their equivalents.

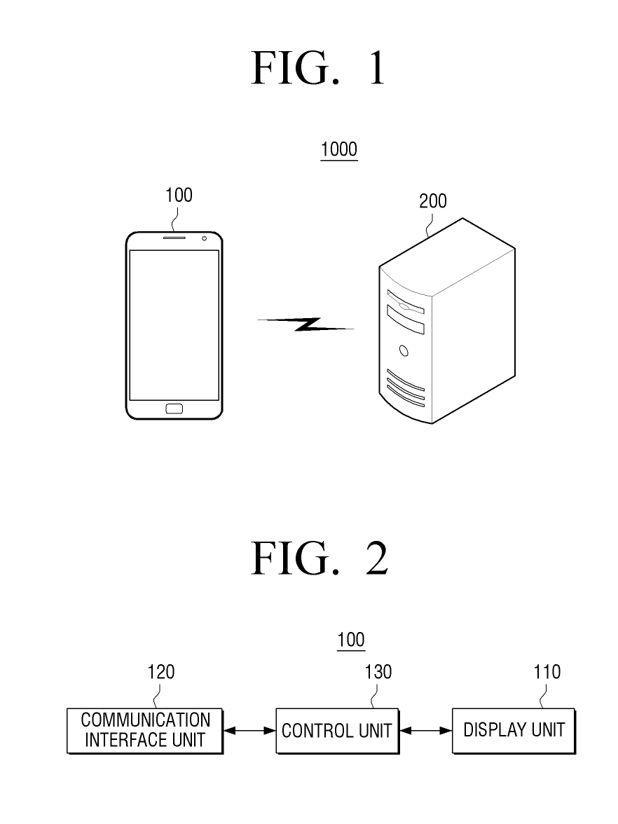

FIG. 1 is a view illustrating an image providing system according to an exemplary embodiment of the present disclosure. According to FIG. 1, the image providing system 1000 includes a client apparatus 100 and server 200. In particular, the client apparatus 100 performs communication with the server 200 and operations, and the server 200 performs communication with the client apparatus to control operations of the client apparatus 100.

For example, an image providing system 1000 according to an exemplary embodiment has all its applications in the server 200, and the client apparatus 100 accesses the server 200 through a network and utilizes the applications in the server 200.

That is, the client apparatus 100 uses a TCP/IP or IPX protocol to access the server where the applications are installed, and transmits a user command to the server 200 to drive an application stored in the server 200. The server 200 drives the application at a request from the client apparatus 100, and transmits a result of executing the application to the client apparatus 100 through the network. In addition, the client apparatus 100 provides the result of executing the application received from the server 200 to the user.

As discussed above, according to an exemplary embodiment, the client apparatus 100 may be embodied as a thin client apparatus or zero client apparatus. That is, the client apparatus 100 may have a CPU which performs a less functions than a fat client, and may decode a compressed image received from the server and display the image on a screen according to the result of executing the application.

In the aforementioned exemplary embodiment, the client apparatus 100 drives the application stored in the server 200 and receives the results, but this is merely an exemplary embodiment. That is, the client apparatus 100 may drive not only an application but also an OS (Operation System) program or application program stored in the server 200, and receive and output the execution results.

Below is a more detailed explanation on the client apparatus 100 and server 200 according to an exemplary embodiment, with reference to the attached views.

FIG. 2 is a block diagram illustrating a configuration of a client apparatus according to an exemplary embodiment of the present disclosure. According to FIG. 2, the client apparatus 100 includes a display unit 110 (e.g., a display), communication interface unit 120 (e.g., a communication interface), and control unit 130 (e.g., a controller).

As illustrated in FIG. 1, the client apparatus 100 may be embodied as a thin client apparatus or zero client apparatus, and more desirably, the client apparatus 100 may be embodied as a portable display apparatus (for example, mobile phones, smart phones, PMPs, PDAs, tablet PCs, navigations, and network monitors) which may be connected to the server 200 through a network and output images. However, the client apparatus is not limited thereto, and thus any electronic apparatus that may be connected to a server through a wired or wireless connection and output images may be a client apparatus 100 according to the present disclosure.

The display unit 110 may display an image. More specifically, the display unit 110 may be embodied as a Liquid Crystal Display (LCD), Organic Light Emitting Display (OLED) or Plasma Display Panel (PDP), and display an image received from the server 200 according to a result of executing an application.

The display unit 110 receives an input from a user's touch manipulation through a touch sensor. More specifically, the display unit 110 may use a touch sensor placed in its front surface to perceive a touch manipulation being input from a user's finger, a stylus pen, etc.

The communication interface unit 120 transmits information corresponding to the user's touch manipulation to the server 200. In addition, the interface unit 120 may transmit a user command for driving an application stored in the server 200 to the server 200.

To this end, the communication interface unit 120 may be equipped with a wired communication port such as a network interface card (not illustrated). or a wireless communication module which supports communication with a network such as a 3G network or Wifi network, to perform communication with the server 200 through a network such as the Internet.

The control unit 130 may be embodied as a CPU and control the overall operations of the client apparatus 100.

More particularly, when a user's touch manipulation for executing an application stored in the server 200 is input through the display unit 110, the control unit 130 transmits a command for executing the corresponding application to the server 200 through the communication interface unit 120.

Next, when an image compressed according to a result of executing the application is received from the server 200, the control unit 130 performs a signal processing such as decoding on the compressed image and displays the signal processed image through the display unit 110.

When the user's touch manipulation is input while the image according to the execution of the application is displayed, the control unit 130 detects the information about the location where the user's touch manipulation is input on the display unit 110 and transmits the detected location information to the server 200.

For example, the control unit 130 may detect the information about the location where the user's touch manipulation is input based on a change such as a pressure applied on a certain portion of the display unit 110 or a capacitance occurring in the certain portion of the display unit 110, and transmit the information on the location where the touch manipulation is performed to the server 200, through the communication interface unit 120.

Herein, the location information may be coordinate information. That is, the control unit 130 may control the communication interface unit 120 to detect the location where the user's touch manipulation is input as coordinate information based on a resolution of the image displayed on the display unit 110, and to transmit the coordinate information to the server 200.

In addition, when the image corresponding to the touch manipulation is received from the server 200 through the communication interface unit 120, the control unit 130 may control the display unit 110 so that the received image is displayed on the display unit 110. More specifically, the control unit 130 may control the communication interface unit 120 to receive the image corresponding to the detected location information from the server 200.

In this case, if the detected location information corresponds to a text area of the image displayed on the display unit 110, the control unit 130 may receive an image which includes a virtual keyboard from the server 200 and display the image. The text area refers to an area where a text may be input. For example, in a case where a web page screen is displayed on the display unit 110 according to the execution of the application, the text area may include an address window of the web page, a search window included in the web page, an ID/password input window included in the web page or a text input window of a bulletin board included in the web page.

When the user's touch manipulation is input while the image which includes the virtual keyboard is being output, the control unit 130 may redetect the information on the location where the user's touch manipulation is input on the display unit 110 and retransmit the detected location information to the server 200, and control so that the image corresponding to the redetected location information is received and displayed. In this case as well, the control unit 130 may calculate the location where the user's touch manipulation is input as the coordinate information, and transmit the coordinate information to the server 200, through the communication interface unit 120.

The control unit 130 detects the location information on the touch input through the display unit 110, but this is merely an exemplary embodiment. For example, in a case where the client apparatus 100 is embodied as a zero client apparatus which includes a CPU which performs fewer functions than the thin client apparatus, a touch sensor provided in the display unit 110 may directly detect the information on the location where the touch occurs, and transmit the detected result to the control unit 130. In this case, the control unit 130 may control the communication interface unit 120 to transmit the location information received from the display unit 110 to the server 200.

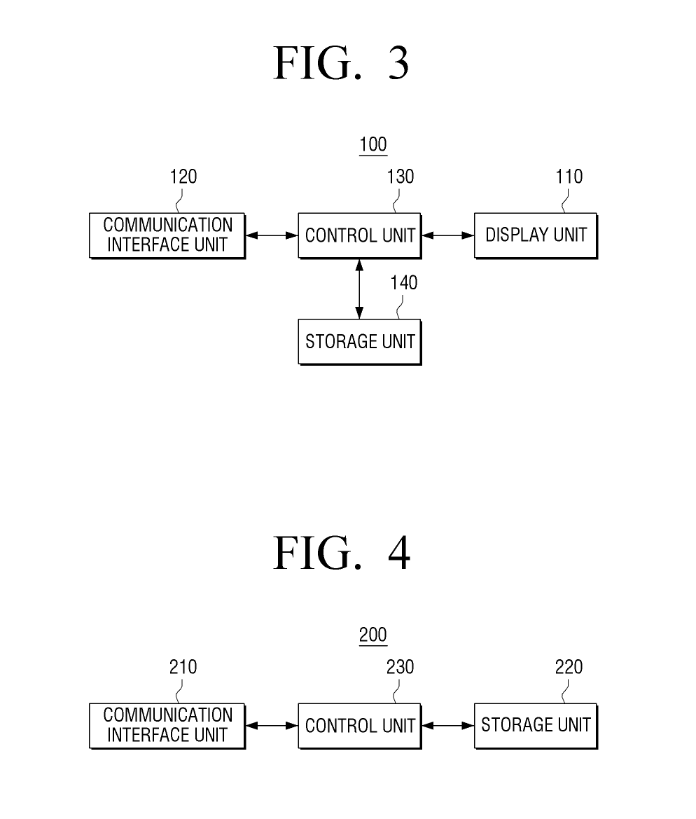

In addition, the control unit 130 may control the communication interface unit 120 to detect information on a type of the touch manipulation input through the display unit 110, and to transmit the detected information to the server 200. Herein, the information on the type of the touch may include a tap, tap & hold, multi tap, drag, and flick, etc. Below is a detailed explanation with reference to FIG. 3.

FIG. 3 is a block diagram illustrating a detailed configuration of a client apparatus according to an exemplary embodiment of the present disclosure. According to FIG. 3, the client apparatus 100 includes a display unit 110, communication interface unit 120, control unit 130, and storage unit 140 (e.g., storage). Since elements having the same reference numerals as FIG. 2 perform the same functions, repeated explanation on these elements will be omitted when explaining FIG. 3.

The display unit 110 may receive an input of a user's touch manipulation to control the execution of an application, and display an image received through the communication interface unit 120 according to the execution of the application.

The storage unit 140 stores mapping information mapped by the type of the user's touch manipulation. For example, in a case where the application executed in the server 200 may receive an input of a mouse manipulation, the mapping information may be mouse manipulation information mapped by the type of the touch manipulation. That is, the storage unit 140 maps the user's touch manipulation on at least one mouse manipulation of a left button click of the mouse, right button click of the mouse, left button click and hold of the mouse, right button click and hold of the mouse, and scroll wheel rotation, and stores a mapping table as in Table 1 below.

TABLE 1

| Touch manipulation | Mouse manipulation |
|---|---|
| Single Tap | Left button click of the mouse |
| Multi Tap | Right button click of the mouse |
| Single tap and hold | Left button click and hold of the mouse |
| Multi tap and hold | Right button click and hold of the mouse |
| Flick (left-right or top-down) | Scroll wheel rotation |

To this end, the storage unit 140 may include at least one type of storage medium from among a flash memory type, hard disk type, multimedia card micro type, card type memory (for example SD or XD memory etc.), RAM, and ROM.

The control unit 130 may control the communication interface unit 120 to determine the type of the user's touch manipulation, and to transmit the mapping information corresponding to the type of the user's touch manipulation to the server 200. In this case, the control unit 130 may control the communication interface unit 120 to transmit information on the location where the touch manipulation is input together with the mapping information, to the server 200.

For example, the control unit 130 may detect a mouse manipulation corresponding to the type of the touch manipulation with reference to the mapping table as in Table 1, and transmit the detected mouse manipulation information to the server 200, through the communication interface unit 120.

That is, when it is determined that the touch manipulation input by the user is a flick, the control unit 130 may control the communication interface unit 120 to transmit a scroll wheel rotation command to the server 200. Further, when it is determined that the touch manipulation input by the user is a single tap, the control unit 130 may control the communication interface unit 120 to transmit a left button click of the mouse command to the server 200.

The server 200 may execute in the application which is operating according to the mouse manipulation, based on the received information on the mouse manipulation and the information on the location where the touch manipulations are made. Furthermore, the server 200 may transmit an image which is reconfigured according to a result of executing the mouse manipulation to the client apparatus 100, and the control unit 130 may receive the reconfigured image from the server 200 and output the image through the display unit 110.

The control unit 130 transmits the detected mapping information to the server 200 according to the type of the touch manipulation, but this is merely an exemplary embodiment when the client apparatus 100 is embodied as a thin client apparatus. That is, in a case where the client apparatus 100 is embodied as a zero client apparatus, the control unit 130 may control the communication interface unit 120 to transmit the information on the type of the touch manipulation itself to the server 200 without additionally detecting the mapping information. In this case, the server 200 may execute in the application which is operating the mouse manipulation, based on the information on the type of the touch manipulation and the information on the location where the touch manipulation is made.

FIG. 4 is a block diagram illustrating a configuration of a server according to an exemplary embodiment of the present disclosure. According to FIG. 4, the server 200 includes a communication interface unit 210, storage unit 220, and control unit 230.

The communication interface unit 210 receives information corresponding to the user's touch manipulation input in the client apparatus 100. More specifically, the communication interface unit 210 may receive from the client apparatus 100 at least one of a command for executing the application, information on the location where the user's touch manipulation is input, and mapping information corresponding to the type of the touch manipulation.

The communication interface unit 210 may have a wired communication port such as a network interface card (not illustrated), or a wireless communication module which supports a communication network such as Wifi network, and perform communication with the client apparatus 100 through the network such as the Internet, etc.

The storage unit 220 may store at least one of various applications, OS programs and application programs for executing the server 200. To this end, the storage unit 220 may include at least one type of storage medium from among a flash memory type, hard disk type, multimedia card micro type, card type memory (for example SD or XD memory etc.), RAM, and ROM.

The control unit 230 controls the overall operations of the server 200. For example, the control unit 230 executes the application according to a request by the client apparatus 100. That is, when a user command for executing the application stored in the storage unit 220 is received through the communication interface unit 210, the control unit 230 executes the corresponding application.

In addition, the control unit 230 controls so that the result of executing the application is transmitted to the client apparatus 100. More specifically, the control unit 230 may compress the image generated according to the execution of the application to the client apparatus 100 through the communication interface unit 210.

The control unit 230 may control the communication interface unit 210 to generate an image corresponding to the user's touch manipulation based on the information corresponding to the touch manipulation received from the client apparatus 100, and to transmit the generated image to the client apparatus 100.

More specifically, the control unit 230 may control the communication interface unit 210 to receive the information on the location where the user's touch manipulation is input from the client apparatus 100, and to generate an image corresponding to the location information and transmit the image to the client apparatus 100. That is, based on the location information received from the client apparatus 100, the control unit 230 may determine which point the user touched in the image generated according to the execution of the application and generate an image corresponding to the result of determination.

The control unit 230 may determine whether or not the information on the location where the user's touch manipulation is input corresponds to the text area of the image displayed on the client apparatus 100, and when the location information corresponds to the text area, may control the server 200 so that an image which includes a virtual keyboard is generated and transmitted to the client apparatus 100.

For example, in a case where the control unit 230 accesses a web page according to the command to drive the application received from the client apparatus 100, and transmits the accessed web page screen to the client apparatus 100.

When it is determined that the user's touch manipulation is made in the text area of the web page in the client apparatus 100 based on the location information received from the client apparatus 100, the control unit 140 may generate an image so that the virtual keyboard is included in the corresponding web page, and may transmit the generated image to the client apparatus 100 through the communication interface unit 210.

When the location information on the touch manipulation is received from the client apparatus 100 after the image which includes the virtual keyboard is transmitted to the client apparatus 100, the control unit 230 may determine which key in the virtual keyboard is input, and may control the server 200 so that the image is reconfigured according to the result of determination and is transmitted to the client apparatus 100.

For example, when it is determined that an “A” key in the virtual keyboard is touched by the user according to the location information on the touch manipulation received from the client apparatus 100, the control unit 230 may reconfigure the image to include “A” in the text area, and transmit the image to the client apparatus 100 through the communication interface unit 210.

The control unit 230 may control the server 200 so that the mapping information corresponding to the type of the touch manipulation is received, and the image is reconfigured according to the received mapping information and then transmitted to the client apparatus 100.

For example, when it is determined that the user's touch manipulation is made in the text area of the web page, the control unit 230 may determine which touch manipulation is input in the text area of the web page based on the received mapping information, and generate an image reconfigured according to the result of determination.

That is, if the mapping information received from the client apparatus 100 is a command of a left button click of mouse, the control unit 230 may reconfigure the web page screen to include the virtual keyboard according to the command of a left button click of mouse.

In addition, if the mapping information received from the client apparatus 100 is a command of a right button click of mouse, the control unit 230 may reconfigure the web page screen to include a menu window according to the command of the right button click of mouse.

Further, if it is determined that the user's touch manipulation is made outside the text area of the web page, the control unit 230 may determine which touch manipulation is input outside the text area of the web page based on the received mapping information, and generate the image reconfigured according to the result of determination.

For example, if the mapping information received from the client apparatus 100 is a command of a scroll wheel rotation, the control unit 230 may reconfigure the image to include a top end or low end of the web page currently being displayed on the client apparatus 100 according to the scroll wheel command.

The server 200 may receive the mapping information detected according to the type of the touch manipulation. That is, in a case where the client apparatus 100 is embodied as a zero client apparatus, the client apparatus 100 may transmit the information on the type of the touch manipulation itself to the server 200.

In this case, the storage unit 220 may store the mapping information mapped by type of the user's touch manipulation. That is, in a case where the application stored in the storage unit 220 may receive an input of a mouse manipulation, the mapping information stored in the storage unit 220 may be mouse manipulation information mapped by type of the touch manipulation as Table 1.

Accordingly, the control unit 230 may control the server 200 so that an image is reconfigured according to the type of the touch manipulation and is transmitted to the client apparatus 100, based on the information on the type of the touch manipulation. That is, the control unit 230 may detect the mouse manipulation corresponding to the type of the touch manipulation with reference to the mapping table as in Table 1, and reconfigure the image according to the detected mouse manipulation, and transmit the image to the client apparatus 100 through the communication interface unit 120.

For example, when the type of the touch manipulation received from the client apparatus 100 is a flick, the control unit 230 may control the application to read a scroll wheel command corresponding to the flick based on the mapping table, and reconfigure the image to include a top end or low end of the web page displayed on the client apparatus 100, and transmit the image to the client apparatus 100 through the communication interface unit 210.

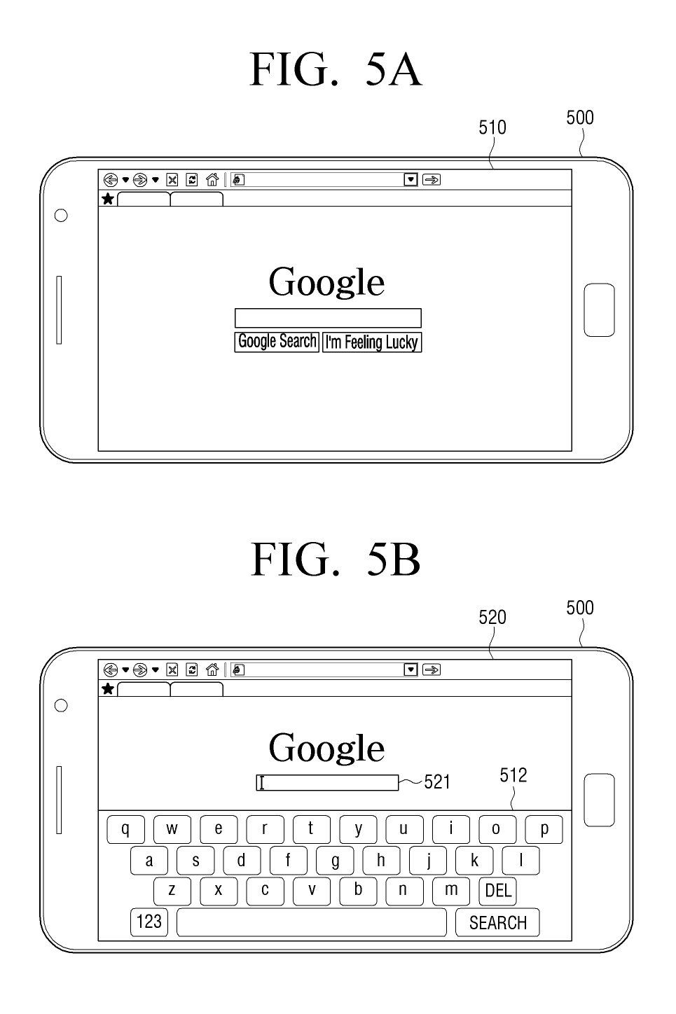

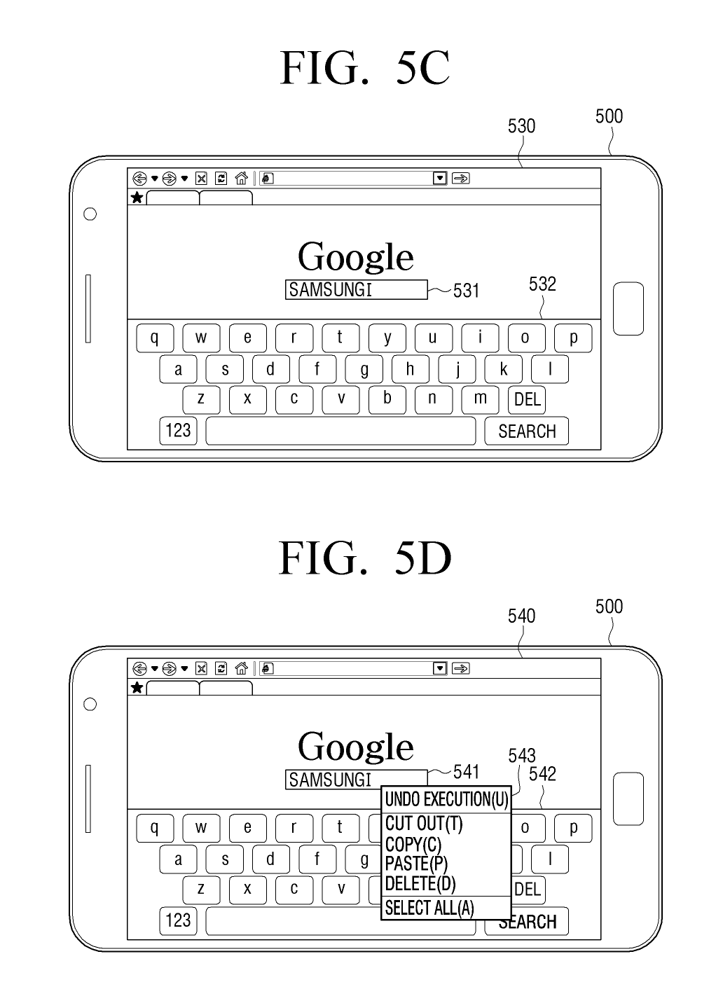

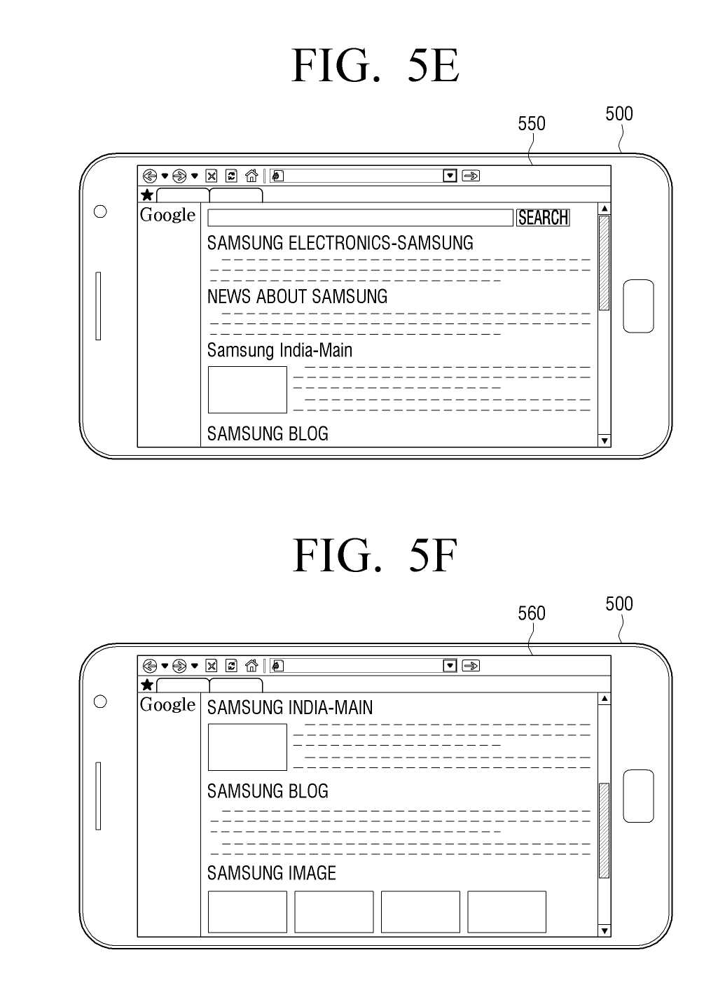

FIGS. 5A to 5F are views illustrating an image displayed on a client apparatus according to an exemplary embodiment of the present disclosure.

First of all, the client apparatus transmits a command for executing an application to the server, and receives and outputs the result of executing the application accordingly. For example, as illustrated in FIG. 5A, the client apparatus 500 transmits a command for accessing a web page to the server (not illustrated), and receives a certain web page screen 510 according to a result of accessing the web page from the server and displays it.

Next, when a user's touch manipulation is input, the client apparatus may transmit information on a location where the touch manipulation is performed to the server. In this case, when the location where the touch manipulation is performed corresponds to a text area, the server may generate an image which includes a virtual keyboard and transmit the image to the client apparatus.

That is, as illustrated in FIG. 5B, when the user's touch is performed in a search window 521 of the web page, the client apparatus 500 may receive the web page screen 520 which includes the virtual keyboard 512 and output it.

Next, when the user's touch manipulation is performed in the image which includes the virtual keyboard, the client apparatus may retransmit the information on the location where the touch manipulation is input to the server, and receive and output the corresponding reconfigured image.

For example, as illustrated in FIG. 5C, when the user's touch manipulation is input in “s,a,m,s,u,n,g” consecutively on the virtual keyboard 532, the client apparatus 500 consecutively transmits information on the location where the touch is performed.

Accordingly, the client apparatus 500 may consecutively receive and output a web page screen where “s” is displayed in the text area, a web page screen where “s,a” is displayed in the text area, a web page screen where “s,a,m” is displayed in the text area, a web page screen where “s,a,m,s” is displayed in the text area, a web page screen where “s,a,m,u” is displayed in the text area, a web page screen where “s,a,m,s,u,n” is displayed in the text area, and a web page screen where “s,a,m,s,u,n,g” is displayed in the text area. However, for convenience of explanation, FIG. 5C only illustrates the client apparatus 500 receiving and outputting the web page screen 530 where “s,a,m,s,u,n,g” is displayed in the text area 531.

The client apparatus may transmit the mapping information corresponding to the type of the user's touch manipulation and the information on the location where the touch manipulation is performed to the server, and receive and output the image reconfigured accordingly.

For example, in a case where a multi tap from the user is performed in the text area. In this case, the client apparatus may transmit a command of a right button click of mouse to the server together with the information on the location where the multi tap is input as the mapping information corresponding to the multi tap.

Accordingly, the server applies a right button click function of mouse on the text area of the web page and reconfigures the image, and transmits the reconfigured image to the client apparatus. That is, as illustrated in FIG. 5D, the client apparatus 500 may receive a web page screen 540 which includes a text area 541, virtual keyboard 542 and a menu window 543 according to the right button click of mouse, from the server and output the web page screen 540.

In another aspect of an exemplary embodiment, where the user's single tap is made in the “search” location of the virtual keyboard, on the web page screen as in FIG. 5C. In this case, the client apparatus 500 transmits a command of a left button click of mouse to the server as the information on the location where the user's touch manipulation is made and the mapping information corresponding to the single tap.

The server performs a search for a letter input in the text area 531, and transmits an image reconfigured according to the searched result to the client apparatus 500, based on the location information and mapping information received from the client apparatus. Accordingly, as illustrated in FIG. 5E, the client apparatus 500 receives a search result web page 550 regarding “SAMSUNG” included in the text area from the server and displays it.

In another aspect of an exemplary embodiment, a flick manipulation is input from the user in a state where the search result web page is displayed on the client apparatus. In this case, the client apparatus 500 transmits a scroll wheel rotation command to the server as the mapping information corresponding to the flick, and the server applies the scroll wheel command on the web page and reconfigures the web page and transmits it to the client apparatus 500. Accordingly, as illustrated in FIG. 5F, the client apparatus 500 may receive the web page screen 560 reconfigured according to the scroll wheel rotation from the server and display it.

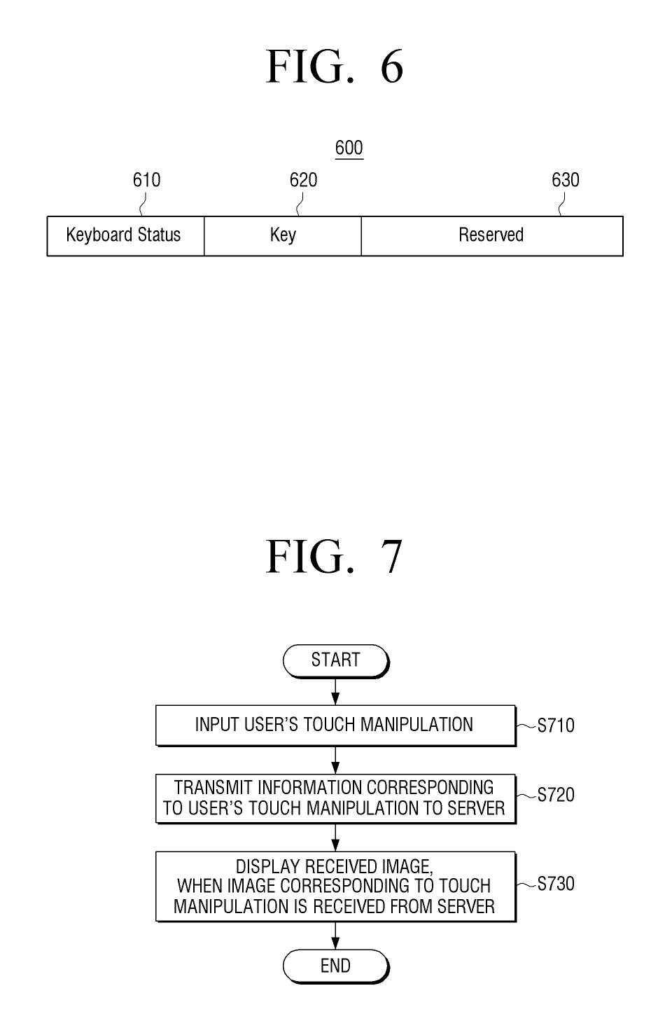

FIG. 6 is a view illustrating a transmission packet which the client apparatus transmits to the server according to an exemplary embodiment of the present disclosure. In explaining FIG. 6, FIGS. 2 to 4 are referred to for convenience of explanation.

As illustrated in FIG. 6, the transmission packet 600 which the client apparatus 100 transmits to the server 200 may include a keyboard status area 610 where information on a utilization state of the virtual keyboard is inserted, a key area 620 where key information is inserted, and a reserved area 630.

The information on the utilization state of the virtual keyboard refers to information for expressing whether or not the image displayed in the client apparatus 100 includes the virtual keyboard. Such information may be detected from the client apparatus 100 or server 200.

In an example where the information from the client apparatus 100 is detected, the control unit 130 analyzes the image displayed on the display unit 110, and detects whether or not the virtual keyboard is included in the displayed image.

In another example, the server 200 may detect information indicating whether or not the image displayed includes the virtual keyboard, and transmit the information to the client apparatus 100.

That is, the control unit 230 determines which point the user touched in the image displayed on the client apparatus 100, based on the information on the location where the user's touch manipulation received from the client apparatus 100 is input.

When it is determined that the user's touch manipulation is made in the text area of the image displayed on the client apparatus 100, the control unit 230 may transmit information expressing that the reconfigured image includes the virtual keyboard to the client apparatus 100 together with the image reconfigured to include the virtual keyboard. Accordingly, the client apparatus 100 comes to check whether or not the virtual keyboard is included in the image currently being displayed.

As discussed above, the reason why the information which indicates whether or not the client apparatus 100 currently displays the virtual keyboard is included in the transmission packet 600 is to prevent malfunction. That is, it is to have the server 200 refer to whether or not the current virtual keyboard is displayed on the client apparatus 100, in reconfiguring the image based on the location information and mapping information received from the client apparatus 100.

The key information may include at least one of the information on the location where the user's touch manipulation is made on the display unit 110 and the mapping information corresponding to the type of touch.

FIG. 7 is a flowchart illustrating a control method of a client apparatus according to an exemplary embodiment of the present disclosure. In particular, FIG. 7 illustrates a control method of a client apparatus which performs communication with the server and operates, and the client apparatus may be embodied as a thin client apparatus or zero client apparatus.

First, the user's touch manipulation is input through a touch sensor (S710), and information corresponding to the user's touch manipulation is transmitted to the server (S720).

More specifically, it is possible to detect the information on the location where the user's touch manipulation is input, and transmit the detected location information to the server and receive the image corresponding to the detected location information from the server.

The location information may be coordinate information. That is, it is possible to calculate the location where the user's touch manipulation is input as the coordinate information based on the resolution of the image being displayed, and transmit the coordinate information to the server.

In addition, when the image corresponding to the touch manipulation is received from the server, the received image is displayed (S730).

More specifically, when the detected location information corresponds to the text area of the image displayed, it is possible to receive the image which includes the virtual keyboard from the server and display the image. Herein, the text area refers to an area where a text may be input. For example, in a case where the web page screen is displayed according to the execution of the application, the text area may include an address window of the web page, a search window included in the web page, an ID/password input window included in the web page or a text input window of a bulletin board included in the web page.

A control method of a client apparatus according an exemplary embodiment of the present disclosure may store mapping information mapped by type of the user's touch manipulation.

In another example where the application executed in the server may receive an input of a mouse manipulation, the mapping information may be mouse manipulation information mapped by type of the touch manipulation. As illustrated in Table 1, it is possible to map the user's touch manipulation to at least one mouse manipulation of the right button click of mouse, right button click of mouse, left button click and hold of mouse, right button click and hold of mouse, and scroll wheel rotation, and store it in a mapping table format.

Accordingly, it is possible to determine the type of the user's touch manipulation, and transmit the mapping information corresponding to the type of the user's touch manipulation to the server. In this case, it is possible to transmit the mapping information corresponding to the type of the user's touch manipulation to the server together with the information on the location where the user's touch manipulation is input, and receive the image corresponding thereto and display the received image.

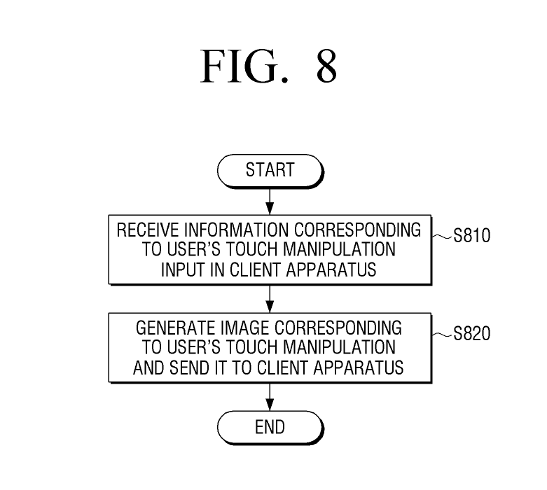

FIG. 8 is a flowchart illustrating an image providing method of a server according to an exemplary embodiment of the present disclosure. In particular, FIG. 8 illustrates an image providing method of a server which performs communication with the client apparatus and controls operations of the client apparatus, and the client apparatus may be embodied as a thin client apparatus or zero client apparatus.

First, information corresponding to a user's touch manipulation input in the client apparatus is received (S810).

More specifically, according to the user's touch manipulation input in the client apparatus, at least one of a command for driving an application, information on a location where the user's touch manipulation is input and mapping information corresponding to a type of the touch manipulation may be received from the client apparatus.

Next, an image corresponding to the user's touch manipulation is generated based on the received information, and the generated image is transmitted to the client apparatus (S820).

More specifically, the information on the location where the user's touch manipulation is input may be received from the client apparatus, and the image corresponding to the location information may be generated and transmitted to the client apparatus. In this case, it is possible to determine whether or not the information on the location where the user's touch manipulation is input corresponds to a text area of the image displayed on the client apparatus, and if the location information corresponds to the text area, it is possible to generate an image which includes a virtual keyboard and transmit the image to the client apparatus.

For example, when a user command for executing the application is input from the client apparatus, the corresponding application is driven, and the image generated accordingly is compressed and transmitted to the client apparatus.

Next, when the information on the location where the user's touch manipulation is input is received from the client apparatus, it is possible to determine which point the user touched in the image generated according to the execution of the application, and generate the image corresponding to the location information according to the result of determination. That is, when it is determined that the user's touch manipulation is input in the text area of the image displayed in the client apparatus, the image which includes the virtual keyboard may be generated and transmitted to the client apparatus.

It is possible to receive the mapping information corresponding to the type of the touch manipulation, and reconfigure the image according to the received mapping information, and transmit the image to the client apparatus.

For example, in a case where it is determined that the user's touch manipulation is made in the text area, it is possible to determine which touch manipulation is input in the text area based on the received mapping information, and generate the image reconfigured according to the result of determination. That is, if the mapping information received from the client apparatus 100 is a command of left button click of mouse, it is possible to reconfigure the image to include the virtual keyboard according to the command of left button click of mouse and transmit the reconfigured image to the client apparatus.

The method of reconfiguring the image in various ways according to the location information and mapping information received from the client apparatus was explained with reference to FIGS. 4 and 5, and thus repeated explanation and illustration are omitted.

A program for performing a method according to various exemplary embodiments of the present disclosure may be stored in various types of recording media and be used.

For example, the code for performing the aforementioned methods may be stored in various types of recording media which can be read in a terminal, such as a RAM (Random Access Memory), flash memory, ROM (Read Only Memory), EPROM (Erasable Programmable ROM), EEPROM (Electronically Erasable and Programmable ROM), register, hard disk, removable disk, memory card, USB memory, and CD-ROM.

Although a few exemplary embodiments have been shown and described, it would be appreciated by those skilled in the art that changes may be made in this embodiment without departing from the principles and spirit of the inventive concept, the scope of which is defined in the claims and their equivalents.

What is claimed is:

1. A client apparatus which performs communication with a server, the client apparatus comprising:
a display which receives a user's touch manipulation through a touch sensor;
a communication interface which transmits information corresponding to the user's touch manipulation to the server; and
a controller which, when an image corresponding to the user's touch manipulation is received from the server through the communication interface, controls the display to display the received image.

2. The client apparatus according to claim 1, wherein the controller detects information on a location where the user's touch manipulation is input on the display, and controls the communication interface to receive an image corresponding to the detected location information from the server.

3. The client apparatus according to claim 2, wherein when the detected location information corresponds to a text area of the image displayed on the display, the controller controls the communication interface to receive an image which includes a virtual keyboard from the server, and controls the display to display the image which includes a virtual keyboard.

4. The client apparatus according to claim 1, further comprising:
a storage which stores mapping information mapped according to a type of the user's touch manipulation,
wherein the controller determines a type of the user's touch manipulation based on the mapping information in the storage, and controls the communication interface to transmit the mapping information corresponding to the type of the user's touch manipulation to the server.

5. The client apparatus according to claim 1, wherein the client apparatus is embodied as a thin client apparatus or a zero client apparatus.

6. A server which performs communication with a client apparatus, and controls operations of the client apparatus, the server comprising:
a communication interface which receives information corresponding to a user's touch manipulation input into the client apparatus; and
a controller which generates an image corresponding to the user's touch manipulation based on the received information, and controls the communication interface to transmit the generated image to the client apparatus.

7. The server according to claim 6, wherein the controller controls the communication interface to receive information on a location where the user's touch manipulation is input from the client apparatus, and
wherein the controller generates an image corresponding to the location information and controls the communication interface to transmit the generated image to the client apparatus.

8. The server according to claim 7, wherein when the controller determines the information on the location where the user's touch manipulation is input corresponds to a text area of the image displayed on the client apparatus, the controller generates an image which includes a virtual keyboard, and controls the communication interface to transmit the image which includes the virtual keyboard.

9. The server according to claim 6, wherein when the controller receives mapping information corresponding to a type of the user's touch manipulation, the controller rearranges the image according to the received mapping information, and controls the communication interface to transmit the rearranged image to the client apparatus.

10. The server according to claim 6, wherein the client apparatus is embodied as a thin client apparatus or a zero client apparatus.

11. A control method for a client apparatus which performs communication with a server, the control method comprising:
receiving an input of a user's touch manipulation through a touch sensor;
transmitting information corresponding to the user's touch manipulation to the server;
receiving an image corresponding to the user's touch manipulation from the server; and
displaying the image received from the server.

12. The control method according to claim 11, further comprising:
detecting information on a location where the user's touch manipulation is input,
wherein transmitting information corresponding to the user's touch manipulation to the server comprises transmitting the detected location information to the server, and
wherein receiving an image corresponding to the user's touch manipulation from the server comprises receiving an image corresponding to the detected location information from the server.

13. The control method according to claim 12, wherein the received image includes a virtual keyboard when the detected location information corresponds to a text area of the displayed image.

14. The control method according to claim 11, further comprising:
storing mapping information mapped according to a type of the user's touch manipulation; and
determining a type of the user's touch manipulation based on the stored mapping information; and
transmitting mapping information corresponding to the type of the user's touch manipulation to the server.

15. The control method according to claim 11, wherein the client apparatus is embodied as a thin client apparatus or a zero client apparatus.

16. An image providing method of a server which performs communication with a client apparatus and controls operations of the client apparatus, the image providing method comprising:
receiving information corresponding to a user's touch manipulation input into the client apparatus;
generating an image corresponding to the user's touch manipulation based on the received information; and
transmitting the generated image to the client apparatus.

17. The image providing method according to claim 16, wherein the information corresponding to a user's touch manipulation includes information on a location where the user's touch manipulation is input in the client apparatus, and wherein the generated image corresponds to the location information.

18. The image providing method according to claim 17, wherein when the information on the location where the user's touch manipulation is input corresponds to a text area of the image displayed on the client apparatus, the generated image is generated to include a virtual keyboard.

19. The image providing method according to claim 16, further comprising:
receiving mapping information corresponding to a type of the user's touch manipulation; and
rearranging the image according to the received mapping information and transmitting the rearranged image to the client apparatus.

20. The image providing method according to claim 16, wherein the client apparatus is embodied as a thin client apparatus or a zero client apparatus.

21. A client apparatus which performs communication with a server, the client apparatus comprising:
a touch sensor which receives a user's touch manipulation;
a communication interface which transmits information about the user's touch manipulation to the server and receives an image corresponding to the user's touch manipulation from the server; and
a controller which controls a display to display the received image.

22. The client apparatus according to claim 21, further comprising:
a storage which stores mapping information mapped by a type of the user's touch manipulation,
wherein the controller determines the type of the user's touch manipulation based on the mapping information in the storage, and controls the communication interface to transmit the mapping information corresponding to the type of the user's touch manipulation to the server.

23. The client apparatus according to claim 21, wherein the client apparatus is a thin client apparatus or a zero client apparatus.
